(19) United States
(12) Patent Application Publication
(10) Pub. No.: US 2022/0346594 A1
(43) Pub. Date: Nov. 3, 2022

(54) PORTABLE STOVE WITH STABILIZED GAS PRESSURE

(71) Applicant: Chia Ming Liu, Douliu City (TW)

(72) Inventor: Chia Ming Liu, Douliu City (TW)

(21) Appl. No.: 17/352,367

(22) Filed: Jun. 21, 2021

(30) Foreign Application Priority Data
Apr. 30, 2021 (CN) 202120924486.3

(51) Int. Cl. A47J 36/26

(52) U.S. Cl. CPC A47J 36/26

(57) ABSTRACT

A portable stove with stabilized gas pressure has a valve assembly, a gas pressure stabilizer, and a burner. The valve assembly has a body and a valve core. The body has an inlet, an outlet, and a cavity. The valve core is received in the cavity and blocks the inlet and the outlet. The gas pressure stabilizer has a flexible membrane, a pushing assembly, a spindle, and a compression spring. The membrane is configured to isolate the cavity from the outlet. The pushing assembly is mounted on a center of the membrane and abuts the valve core. The spindle has is screwed on the body, and is movable along an axial direction. The compression spring is located in the body, abuts against the spindle and the pushing assembly, and is compressible along the axial direction. The burner is connected with the body.

### BACKGROUND OF THE INVENTION

### 1. Field of the Invention

The present invention relates to a stove, and more particularly to a portable stove with stabilized gas pressure.

### 2. Description of Related Art

Nowadays people in modern society often go hiking, mountain climbing, camping, etc. at leisure to release their stress from work. When people spend their leisure time in the forests or mountains, they might want to drink a cup of tea or coffee or to have a bowl of soup to keep their bodies warm. Hence, people often bring a conventional portable stove when going out for a trip to the forests or the mountains.

However, the conventional portable stove is designed to have light weight and simple configuration to be easy to carry. As a result, the conventional portable stove does not have enough weight to stably stand on the ground. Further, the conventional portable stove lacks a gas pressure stabilizer, so flames flicker as the conventional portable stove shakes due to unstable supply of fuel gas. Moreover, besides disability in steady heating, a sudden jet of the flame may occur and cause harm to people nearby.

### SUMMARY OF THE INVENTION

The main objective of the present invention is to provide a portable stove with stabilized gas pressure, wherein the portable stove has a gas pressure stabilizer having a membrane and a compression spring to stabilize supply of fuel gas.

The portable stove with stabilized gas pressure has a valve assembly, the gas pressure stabilizer, and a burner. The valve assembly has a body and a valve core. The body has an inlet, an outlet, and a cavity communicating with the inlet and the outlet. The valve core is received in the cavity and is capable of blocking the inlet and the outlet. The gas pressure stabilizer has the membrane, a pushing assembly, a spindle, and a compression spring. The membrane is flexible, is located inside the body, and is configured to isolate the cavity from the outlet. The pushing assembly is mounted on a center of the membrane and abuts the valve core. The spindle has an axial direction, is screwed on the body, and is movable along the axial direction. The compression spring is located in the body, abuts against the spindle and the pushing assembly, and is compressible along the axial direction of the spindle. The burner is connected with the body of the valve assembly.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a portable stove with stabilized gas pressure in accordance with the present invention;

FIG. 2 is an enlarged side view in partial section of the portable stove in FIG. 1;

FIG. 3 is an enlarged operational side view in partial section of the portable stove in FIG. 1;

FIG. 4 is an enlarged side view of the portable stove in FIG. 1; and

FIG. 5 is another perspective view of the portable stove in FIG. 1 showing auxiliary supporting sections extending out.

### DETAILED DESCRIPTION OF THE PREFERRED EMBODIMENT

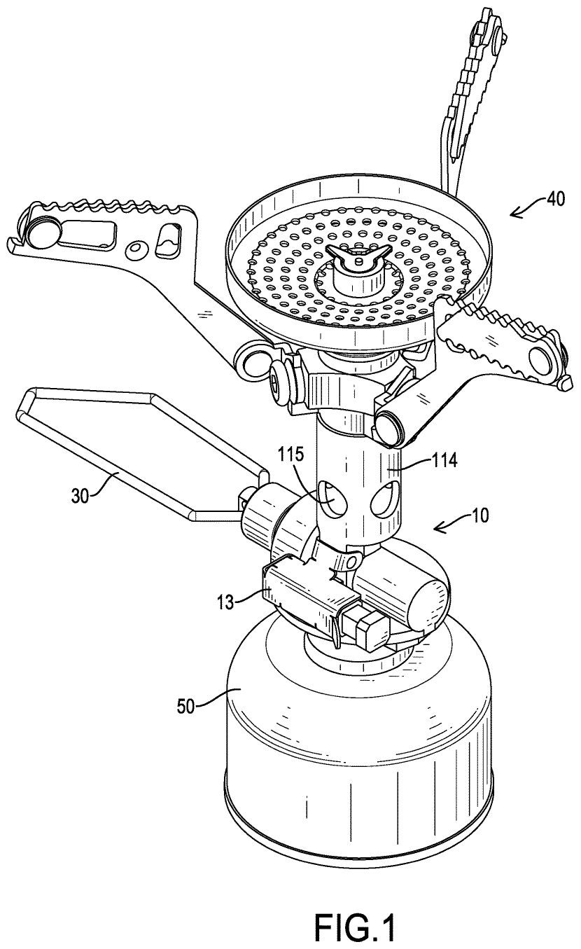

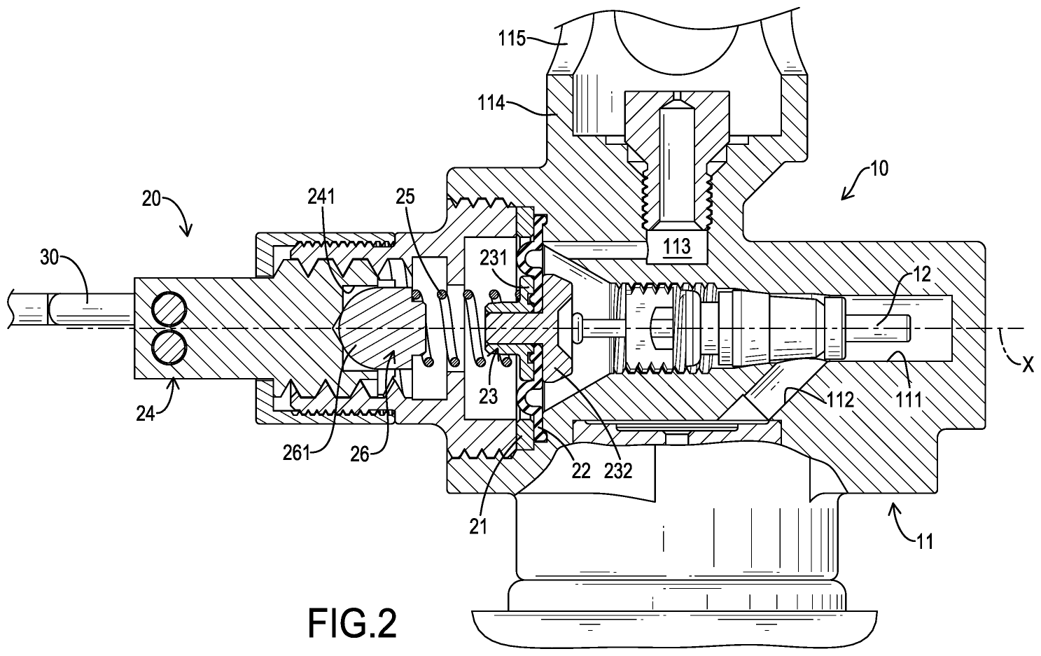

With reference to FIGS. 1 and 2, a portable stove with stabilized gas pressure in accordance with the present invention comprises a valve assembly 10, a sparking device 13, a gas pressure stabilizer 20, a rotary adjusting member 30, and a burner 40. Specifically, in the preferred embodiment of the present invention, the portable stove with stabilized gas pressure is adapted for alpine areas.

With reference to FIGS. 1 and 2, the valve assembly 10 has a body 11 and a valve core 12. The body 11 has a cavity 111, an inlet 112, an outlet 113, and an upright gas mixing segment 114. The inlet 112 and the outlet 113 communicate with each other via the cavity 111. The gas mixing segment 114 is formed tubular, communicates with the outlet 113, and has multiple holes 115 disposed therethrough.

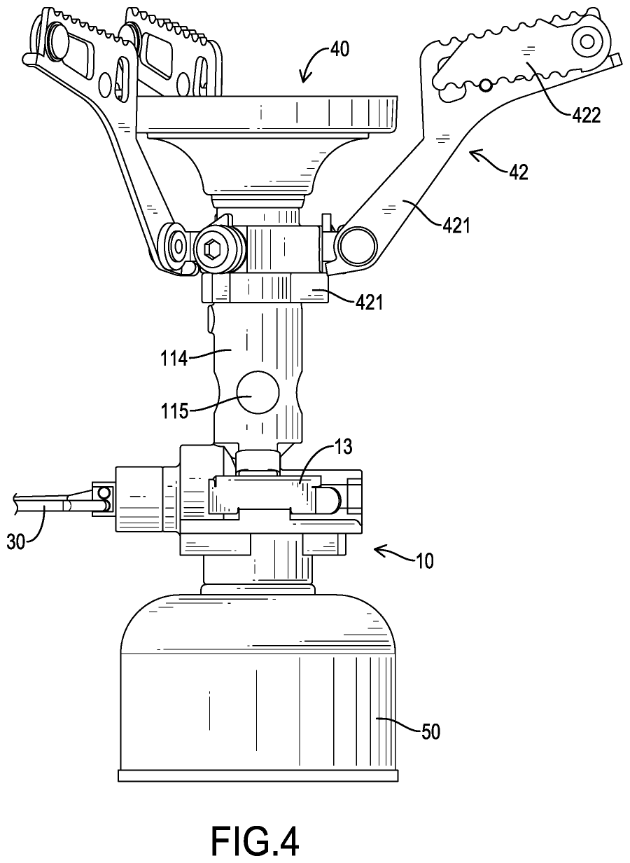

With reference to FIGS. 1 and 2, the valve core 12 is received in the cavity 111 and is capable of blocking the inlet 112 and the outlet 113 such that the inlet 112 and the outlet 113 cannot communicate with each other. Structural technical features and operations of the valve core 12 are conventional, and detailed descriptions are thereby omitted. With reference to FIGS. 1 and 4, the sparking device 13 is disposed transversely.

With reference to FIGS. 1 and 2, the gas pressure stabilizer 20 has an abutting ring 21, a membrane 22, a pushing assembly 23, a spindle 24, a compression spring 25, and a pushing component 26. The abutting ring 21 and the membrane 22 are located in the body 11, and the abutting ring 21 presses a circumference of the membrane 22 so as to position the membrane 22 and to make the membrane 22 cover the cavity 111. In addition, the membrane 22 is flexible. The pushing assembly 23 is mounted on a center of the membrane 22, and abuts the valve core 12. In the preferred embodiment of the present invention, the pushing assembly 23 has a top component 231 and a bottom component 232. The top component 231 and the bottom component 232 are assembled and jointly clamp the membrane 22. The bottom component 232 abuts the valve core 12.

With reference to FIGS. 1 and 2, the spindle 24 has an axial direction X. The spindle 24 is screwed on the body 11, and is movable along the axial direction X. The spindle 24 is parallel to the sparking device 13. The spindle 24 has a groove 241 recessed along the axial direction X and located inside the body 10. The compression spring 25 is located inside the body 11 and has two ends. The compression spring 25 is compressible along the axial direction X of the spindle 24. The pushing component 26 is located in the body 11 between the spindle 24 and the compression spring 25, and has an arc-shaped head 261 movably extending into the groove 241. One of the two ends of the compression spring 25 abuts against the top component 231 of the pushing assembly 23, and the other one of the two ends of the compression spring 25 abuts against the pushing component 26. In this way, when the spindle 24 is rotated and moves along the axial direction X, the compression spring 25 will be firstly compressed and generate a restoring force, and then restores to push the pushing assembly 23.

With reference to FIGS. 1 and 2, the rotary adjusting member 30 forms a frame-like structure and is connected to the spindle 24. A user can hold the rotary adjusting member 30 to rotate the spindle 24, so the spindle 24 may move back and forth along the axial direction X.

With reference to FIGS. 1, 2, and 4, the burner 40 has a burner body and multiple supporting members 42. Each one of the multiple supporting members 42 is connected to the burner body, and has a main supporting section 421 and an auxiliary section 422. The auxiliary section 422 is pivotably mounted with the main supporting section 421.

With reference to FIGS. 1 and 2, a gas cartridge 50 is filled with high-pressure fuel gas, and is mounted to the body 11 of the valve assembly 10 for inputting gas into the inlet 112. Because the valve core 12 blocks the inlet 112 from communicating with the cavity 111, the gas cannot pass through the valve core 112 and enter the outlet 113.

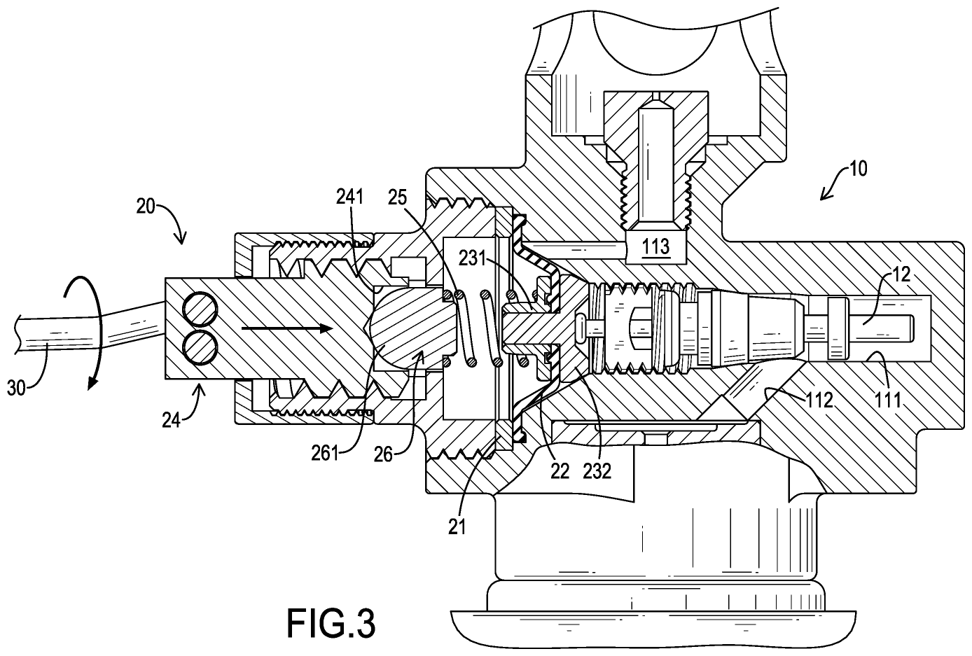

With reference to FIGS. 1 to 3, when the user turns the rotary adjusting member 30 to drive the spindle 24 to extend into the body 11 along the axial direction X, the spindle 24 pushes the pushing component 26, the compression spring 25 becomes compressed by the pushing component 26, and the compression spring 25 further pushes the pushing assembly 23. Afterwards, the pushing assembly 23 pushes the valve core 12 to make the valve core 12 open for the gas to flow through from the inlet 112 to the outlet 113. On the other hand, the membrane 22 deforms as the pushing assembly 23 moves, and thus shields the outlet 113. The gas flowing into the cavity 111 makes a gas pressure in the cavity 111 higher than that in the outlet 113. Therefore, the gas may push part of the membrane 22 away and enter the outlet 113. After the gas passes through the outlet 113 and enters the gas mixing segment 114, the user may operate the sparking device 13 to turn on the gas, so the user may heat up food or water.

In comparison with the conventional portable stove, the present invention adds the gas pressure stabilizer 20, so the membrane 22 and the compression spring 25 can be used to stabilize the gas pressure. Even if the portable stove of the present invention is shaken, gas still needs to push the membrane 22 to enter the outlet 113, and thereby a sudden jet of the flame may be avoided.

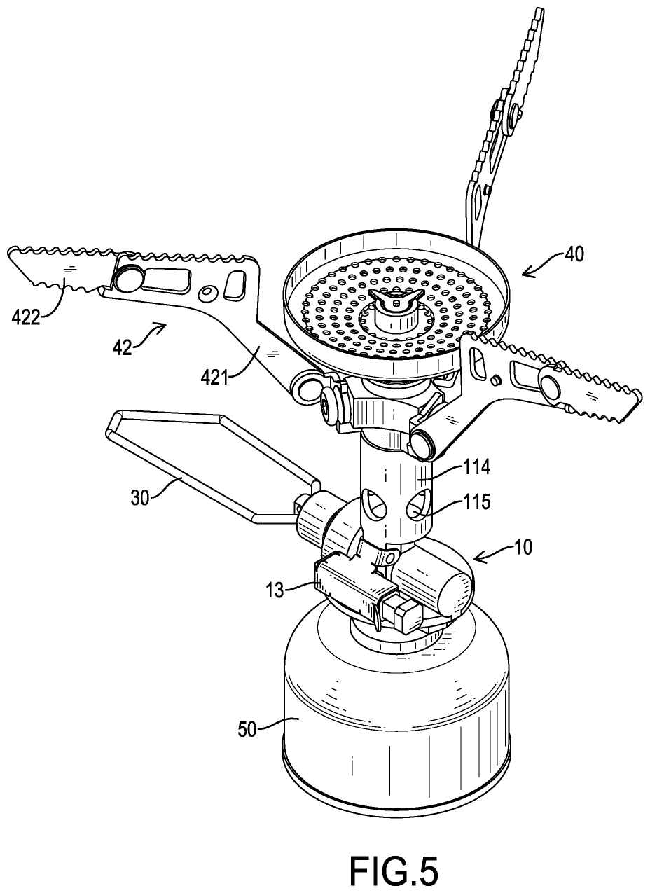

With reference to FIGS. 1, 4, and 5, because the body 11 of the valve assembly 10 has said gas mixing segment 114, and the sparking device 13 is transversely disposed, the user may hold the gas mixing segment 114 with one of the user's two hands, and use the other hand to operate the sparking device 13 to turn on the gas. The portable stove of the present invention is ergonomically designed, facilitating ease in operation.

With reference to FIGS. 1, 4, and 5, the auxiliary supporting section 422 of each one of the multiple supporting members 42 may pivot from the corresponding main supporting section 421. When the user uses a larger cooker, the auxiliary supporting section 422 may be unfolded to support the larger cooker.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A portable stove with stabilized gas pressure, the portable stove comprising:
a valve assembly comprising
a body having an inlet, an outlet, and a cavity communicating with the inlet and the outlet; and
a valve core received in the cavity and being capable of blocking the inlet and the outlet;
a gas pressure stabilizer comprising
a membrane being flexible, located inside the body, and configured to isolate the cavity from the outlet;
a pushing assembly mounted on a center of the membrane and abutting the valve core;
a spindle having an axial direction, screwed on the body, and being movable along the axial direction; and
a compression spring located in the body, abutting against the spindle and the pushing assembly, and being compressible along the axial direction of the spindle; and
a burner connected with the body of the valve assembly.

2. The portable stove with stabilized gas pressure as claimed in claim 1, wherein the gas pressure stabilizer has a pushing component located inside the body and between the spindle and the compression spring, one of two ends of the compression spring abuts against the pushing assembly, and the other one of the two ends of the compression spring abuts against the pushing component.

3. The portable stove with stabilized gas pressure as claimed in claim 2, wherein the spindle has a groove recessed along the axial direction of the spindle, and the pushing component has an arc-shaped head movably extending into the groove.

4. The portable stove with stabilized gas pressure as claimed in claim 3, wherein the pushing assembly comprises a top component and a bottom component, and the top component and the bottom component are assembled and jointly clamp the membrane.

5. The portable stove with stabilized gas pressure as claimed in claim 4, wherein the portable stove has a sparking device, and the sparking device is transversely disposed and extends parallelly to the axial direction of the spindle.

6. The portable stove with stabilized gas pressure as claimed in claim 5, wherein the burner has a burner body and multiple supporting members, and each one of the multiple supporting members is connected to the burner body and has a main supporting section and an auxiliary section pivotably mounted with the main supporting section.

7. The portable stove with stabilized gas pressure as claimed in claim 1, wherein the pushing assembly comprises a top component and a bottom component, and the top component and the bottom component are assembled and jointly clamp the membrane.

8. The portable stove with stabilized gas pressure as claimed in claim 1, wherein the portable stove has a sparking device, and the sparking device is transversely disposed and extends parallelly to the axial direction of the spindle.

9. The portable stove with stabilized gas pressure as claimed in claim 1, wherein the burner has a burner body and multiple supporting members, and each one of the multiple supporting members is connected to the burner body and has a main supporting section and an auxiliary section pivotably mounted with the main supporting section.
